(19) United States
(12) Patent Application Publication
(10) Pub. No.: US 2014/0184428 A1
(43) Pub. Date: Jul. 3, 2014

(54) INTERACTIVE MANAGEMENT OF A PARKED VEHICLE

(71) Applicants: Jennifer A. Healey, San Jose, CA (US); Alexandra C. Zafiroglu, Portland, OR (US)

(72) Inventors: Jennifer A. Healey, San Jose, CA (US); Alexandra C. Zafiroglu, Portland, OR (US)

(21) Appl. No.: 13/728,498

(22) Filed: Dec. 27, 2012

(51) Int. Cl. G08G 1/00

(52) U.S. Cl. CPC G08G 1/00
USPC 340/932.2

(57) ABSTRACT

The present disclosure relates to computer-implemented systems and methods for interactive management of a parked vehicle. An example method may include receiving a first communication, at a server comprising one or more processors, indicating that the parked vehicle is considered an obstruction. The method may further include notifying, by the server, one or more users associated with the parked vehicle of the first communication. Additionally, the method may include generating, by the server, a predetermined response to the first communication associated with the obstruction.

### TECHNICAL FIELD

The present disclosure generally relates to an information system in vehicles, and in particular, to interactive management of a parked vehicle.

### BACKGROUND

In environments where parking spaces for vehicles may be relatively limited, “double parking” may be a common, yet illegal, practice. Double parking may refer to the practice of parking a vehicle to the side of a row of vehicles already parked next to a curb. Double parking may also generally refer to any type of parking that obstructs the ability of another vehicle to leave its parking space. In some instances, double parking may also describe parking in someone else's reserved parking space.

In instances involving double parking, the owner of the obstructed vehicle may experience aggravation and frustration at being unable to leave the parking space. In some circumstances, the frustration may be acute enough that the owner of the obstructed vehicle may be motivated to vandalize or otherwise damage the offending, obstructing vehicle, or may create a public disturbance such as by honking the car horn. Thus, a user of the obstructing vehicle (i.e., the vehicle committing the double parking offense) may desire notice of when his/her vehicle may be considered an obstruction.

### BRIEF DESCRIPTION OF THE DRAWINGS

Reference will now be made to the accompanying figures and diagrams, which are not necessarily drawn to scale, and wherein:

FIG. 1 shows a diagram of a double parked vehicle, according to an example embodiment of the disclosure.

FIG. 2 shows an obstructing vehicle having sensors, according to an example embodiment of the disclosure.

FIG. 3 shows a block diagram of a system for interactive management of a parked vehicle, according to an example embodiment of the disclosure.

FIG. 4 shows an example environment suitable for implementing methods for interactive management of a parked vehicle, according to an example embodiment of the disclosure.

FIG. 5 shows another example environment according to an example embodiment of the disclosure.

FIG. 6 shows a flow diagram of an example environment suitable for implementing methods in a server for interactive management of a parked vehicle, according to an example embodiment of the disclosure.

FIG. 7 shows a flow diagram of an example environment suitable for implementing methods in an in-vehicle computation system for interactive management of a parked vehicle, according to an example embodiment of the disclosure.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, the term “vehicle” may refer generally to an automobile, a car, a truck, a passenger vehicle, a bus, a motorcycle, a personal transportation device, or the like.

As used herein, unless otherwise specified, the term “mobile device” refers, in general, to a wireless communication device, and more particularly to one or more of the following: a portable electronic device, a telephone (e.g., cellular phone, smart phone), a computer (e.g., laptop computer, tablet computer), a portable media player, a personal digital assistant (PDA), or any other electronic device having a networked capability.

As used herein, unless otherwise specified, the term “in-vehicle computation system” may refer to an in-vehicle computing device, a navigational system for use in a vehicle, a vehicle infotainment system, or any other similar system or device.

As used herein, unless otherwise specified, the term “central server” may refer to any computing device having a networked connectivity and configured to provide one or more dedicated services to clients, such as a mobile device or an in-vehicle computation system. The services may include storage of data or any kind of data processing. One example of the central server includes a web server hosting one or more web pages. Some examples of web pages may include social networking web pages.

The present disclosure relates to computer-implemented systems and methods for interactive management of a parked vehicle. According to one or more embodiments of the disclosure, a method is provided. The method may include receiving a first communication, at a server comprising one or more processors, indicating that the parked vehicle is considered an obstruction. The method may further include notifying, by the server, one or more users associated with the parked vehicle of the first communication. Additionally, the method may include generating, by the server, a predetermined response to the first communication associated with the obstruction.

According to one or more embodiments of the disclosure, a vehicle is provided. The vehicle may include one or more sensors for detecting that a person considers the vehicle an obstruction. The vehicle may also include at least one memory for storing data and computer-executable instructions. Additionally, the vehicle may also include at least one processor to access the at least one memory and to execute the computer-executable instructions. Furthermore, the at least one processor may be configured to execute the instructions to detect, via the one or more sensors, that a person considers the vehicle an obstruction. The processor may also be configured to notify one or more users associated with the vehicle of the detection and to communicate, to the person, a predetermined response associated with the obstruction.

According to one or more embodiments of the disclosure, a non-transitory computer-readable medium is provided. The non-transitory computer-readable medium may have embodied thereon instructions executable by one or more processors. The instructions may cause the one or more processors to receive a first communication, at a server comprising at least one of the one or more processors, indicating that a parked vehicle is considered an obstruction. The instructions may also cause the one or more processors to notify, by the server, at least one user associated with the vehicle of the first communication. Moreover, the instructions may cause the one or more processors to generate, by the server in response to the first communication, a predetermined response associated with the obstruction.

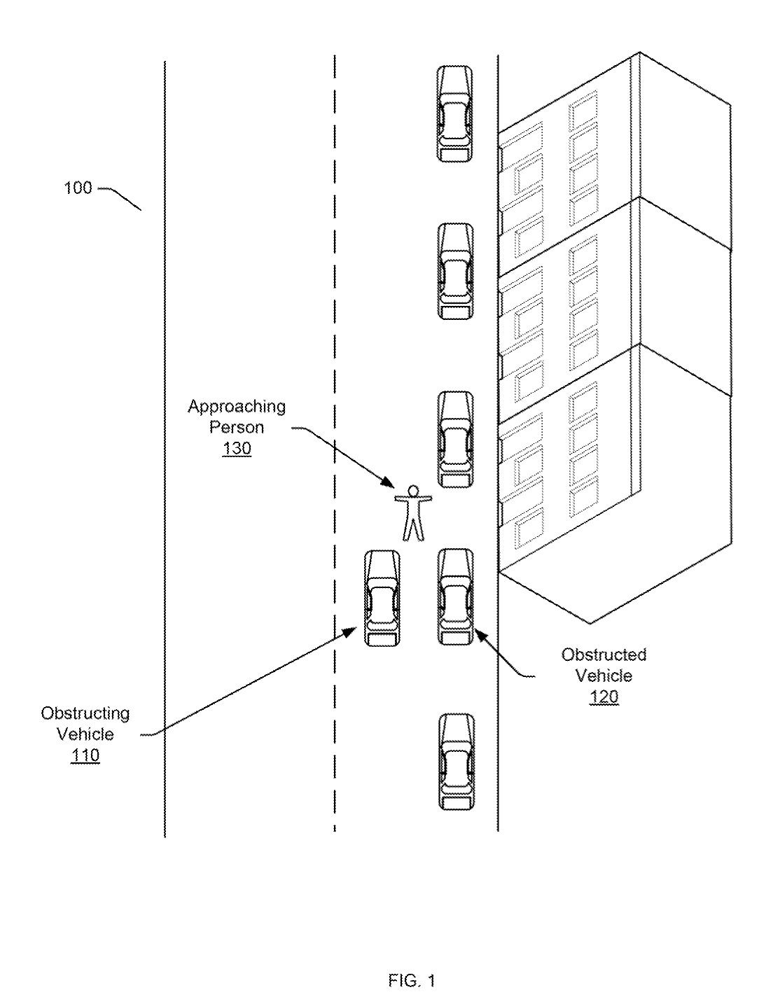

The above principles, as well as perhaps others, are now illustrated with reference to FIG. 1, which depicts a diagram 100 of a double parked vehicle (parking obstruction) related to one or more embodiments of the present disclosure. The diagram 100 may include an obstructing vehicle 110, an obstructed vehicle 120, and an approaching person 130. Both the obstructing vehicle 110 and the obstructed vehicle 120 may be parked. As depicted in the diagram 100, the obstructing vehicle 110 may be parked such that the obstructed vehicle 120 may be unable to leave the space in which it is parked. Thus, the obstructing vehicle 110 may be described as being “double parked.”

According to one or more embodiments, the approaching person 130 may be a driver of the obstructed vehicle 120 or may be a person otherwise associated with an interest in the obstructed vehicle 120. In some instances, the approaching person 130 may be approaching the obstructing vehicle 110 to examine or determine methods of moving the obstructing vehicle 110. According to some embodiments, the approaching person 130 may be likely to cause vandalism or other damage to the obstructing vehicle 110 due to annoyance and frustration resulting from the double parking of the obstructing vehicle 110.

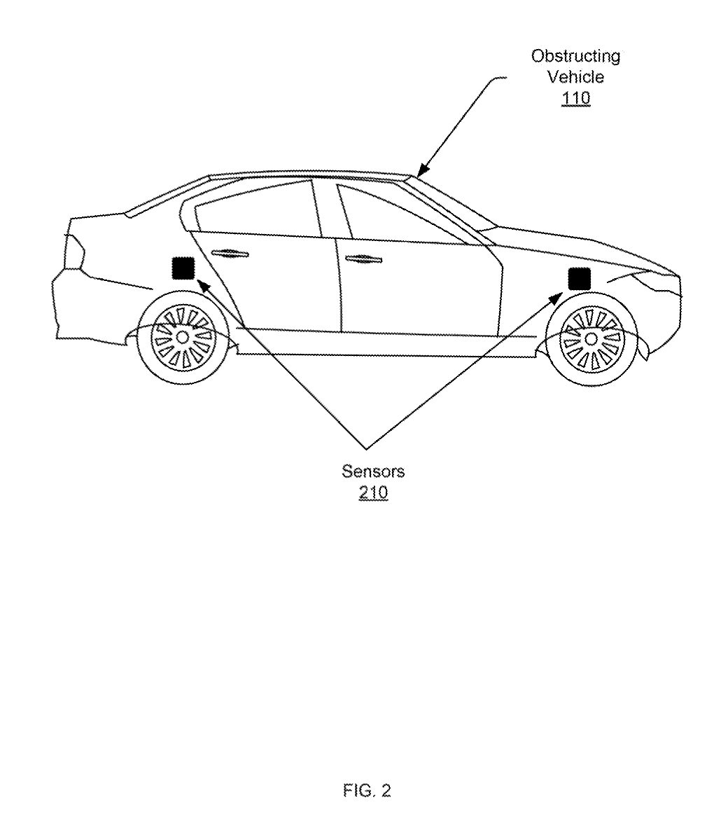

Turning now to FIG. 2, an obstructing vehicle 110 having sensors is illustrated according to one or more embodiments of the present disclosure. While only one obstructing vehicle 110 is illustrated in FIG. 2, it should be understood that multiple obstructing vehicles 110 are also contemplated. The obstructing vehicle 110 may include sensors 210, which may be capable of detecting one or more approaching persons, such as the approaching person 130 depicted in FIG. 1.

While FIG. 2 illustrates two sensors 210 positioned on the exterior of the obstructing vehicle 110, it should be understood that any number of sensors 210 may be associated with obstructing vehicle 110 at any location, both interior and exterior to the obstructing vehicle 110. For example, the sensors 210 may include, but are not limited to, an image capturing device such as a video or photo camera and/or recorder, a motion detecting device, a voice recognition device, a touch recognition device, an accelerometer, an infrared device, a Near-Field Communications (NFC) device, a Bluetooth device, a Quick Response (QR) code, a bar code, a Global Positioning System (GPS), a Wi-Fi device, and/or any other device or system, both wired and wireless, capable of detecting the presence of an approaching person 130.

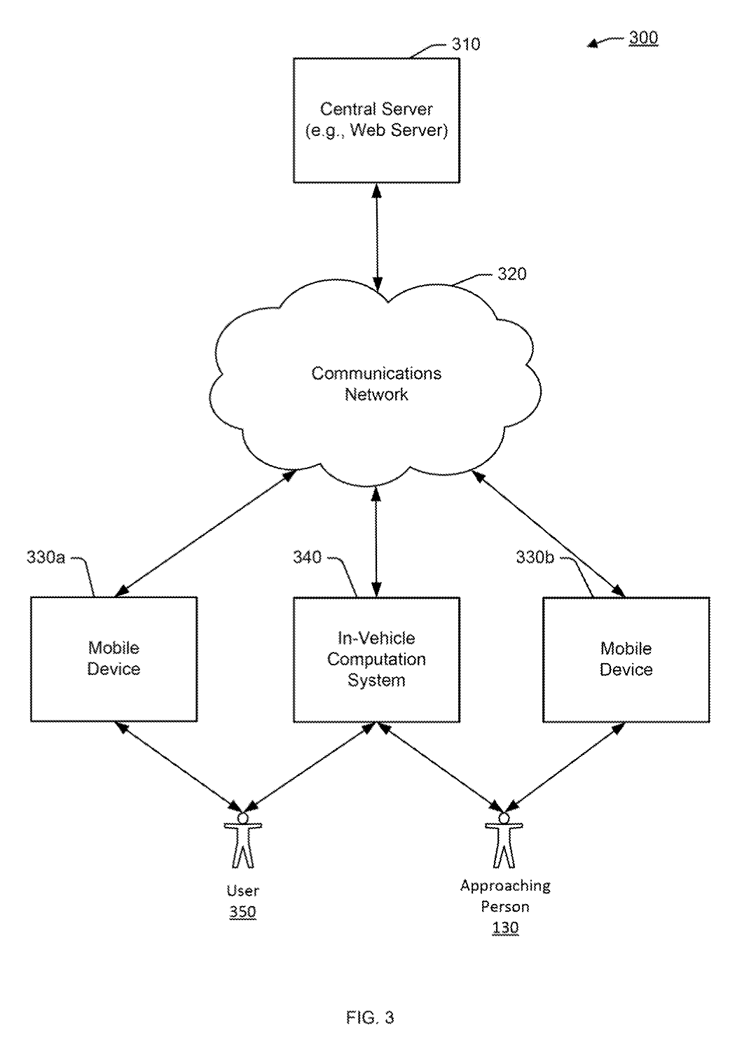

FIG. 3 depicts a block diagram of a system 300 for interactive management of a parked vehicle in accordance with one or more embodiments of the present disclosure. The system 300 may include a central server 310, such as a web server. The central server 310 may be in communication with various other devices (discussed below) through a communications network 320. To this end, the communications network 320 may include a local area network (LAN), a wide area network (WAN), the Internet, a Wi-Fi network, an ad-hoc wireless network, and/or any other wired or wireless network communications interface, whether public or private.

According to one or more embodiments, mobile devices 330a-b and an in-vehicle computation system 340 may also communicate with the central server 310 through the communications network 320. Mobile device 330a may be associated with a user 350. Mobile device 330b may be associated with the approaching person 130. Additionally, the in-vehicle computation system 340 may be included in, or otherwise associated with, the obstructing vehicle 110. In some embodiments, the user 350 may be anyone who holds an interest in an obstructing vehicle 110, whether or not he/she has access to the car. For example, a user 350 could be the driver of the obstructing vehicle 110, an owner, or anyone else who values the fate of the obstructing vehicle 110.

As illustrated in FIG. 3, the in-vehicle computation system 340 may be capable of communicating with both the user 350 and the approaching person 130. Furthermore, the in-vehicle computation system 340 may perform such communication either directly with the user 350 and the approaching person 130 or indirectly through the communications network 320 and the respective mobile devices 330a-b. For example, the in-vehicle computation system 340 may directly communicate with the user 350 and/or approaching person 130 through audio and visual devices such as a display, a speaker, and other interfaces associated with the in-vehicle computation system 340.

In one or more embodiments, the system 300 for interactive management of a parked vehicle may be operable to notify a user 350 that someone (e.g., an approaching person 130) considers the user's 350 vehicle an obstruction (e.g., an obstructing vehicle 110). For example, the in-vehicle computation system 340 may be in communication with sensors 210. The sensors 210 may detect that a person 130 has approached the vehicle. In some instances, this detection may be actively communicated to the in-vehicle computation system 340 by the sensors 210. Alternatively, the sensors 210 may be passive, and the in-vehicle computation system 340 may instead proactively monitor the sensors 210 and determine that an approaching person 130 has been detected via the sensors 210.

Once detection of an approaching person 130 has been determined, the in-vehicle computation system 340 may send a signal to the central server 310, via the communications network 320, indicating the detection. Alternatively, the central server 310 may instead actively monitor the in-vehicle computation system 340. In this scenario, instead of receiving a distinct indication from the in-vehicle computation system 340, the central server 310 may itself actively drive the detection of an approaching person 130.

According to other embodiments, the central server's 310 awareness of an approaching person 130 may be initiated by the approaching person 130 himself/herself. For example, in instances where a sensor 210 is a QR code, the approaching person 130 may use his/her mobile device 330b to scan the QR code. It should be noted that the QR code may also be a digital QR code. To this end, the QR code may be located somewhere on the exterior of the obstructing vehicle 110. The QR code may include a website address, a phone number, an email address, or any other type of information. According to some examples, after scanning the QR code, the mobile device 330b of the approaching person 130 may be served a website by the central server 310. As discussed above, the sensors 210 may also include an NFC device, a Bluetooth device, a Wi-Fi device, or any other type of device that may send and/or receive communications. In such embodiments, the mobile device 330b may receive the same data stored in the QR code from the sensor 210 and then establish communication with the central server 210. It should be noted that any of the devices listed above may also proactively detect the approaching person 130 instead of playing a passive role.

In one or more embodiments, after detection of an approaching person 130, or after the approaching person 130 initiates communication, a website (not illustrated) may be served up to the mobile device 330b of the approaching person 130. The central server 310 or the in-vehicle computation system 340 may be capable of serving up the website. The website may include a user interface to provide various methods for the approaching person 130 to contact one or more users 350 of the obstructing vehicle 110. For example, the website may provide a phone number or any other contact information related to the user(s). As another example, the website may provide multiple options for the approaching person 130 to contact the user(s) 350 (e.g., voice call, email, text, social networking) without disclosing the user's 350 contact information.

In one or more embodiments, the central server 310 and/or the in-vehicle computation system 340 may notify the user 350 that his/her vehicle is considered an obstruction (i.e., an obstructing vehicle 110). For example, the central server 310 may generate and send a signal to the user 350 or the user's 350 mobile device 330a indicating that the vehicle 110 is considered an obstruction.

In other embodiments, the user's mobile device 330a or any other device associated with the user 350 may proactively poll or monitor for detection of an approaching person 130. For instance, once an approaching person 130 has been detected, an indication of such detection may be stored. To this end, the indication may be stored in a memory or other storage device associated with the in-vehicle computation system 340, central server 310, or any other device. Under these scenarios, the user's 350 mobile device 330a may be configured to periodically poll or check the memory or storage area for the indication of a detected approaching person 130. Similarly, either the in-vehicle computation system 340, the central server 310, or both may also be configured to periodically check the memory or storage area.

Furthermore, a user 350 may also determine whether he/she would like to receive notifications regarding an obstructing vehicle 110. For example, an option to receive notifications may be present as a setting in the in-vehicle computation system 340, in the central server 310, or in the user's mobile device 330a. Any of these components may provide a user interface for the user 350 to toggle such a setting according to his/her preferences. For example, if the user 350 knows that he/she will only be double-parked for a relatively short period, the user 350 may elect to not receive notifications since he/she will be able to return relatively quickly to move the obstructing vehicle 110. It should be noted that these examples are merely illustrative and that various other methods of implementing an option to receive notifications related to an obstructing vehicle 110 are also contemplated.

Additionally, in embodiments where more than one user 350 is associated with the obstructing vehicle 110, notifications related to the obstructing vehicle 110 may be sent to all or only a portion of the users 350. For example, notifications may or may not be sent to the users 350 depending on the users' 350 proximity to the obstructing vehicle 110. As another example, the users 350 may be arranged according to a predetermined order in which notifications are first sent to a selected group of users. For example, various information may be considered in determining the order including, but not limited to, location information (e.g., Global Positioning System information or other types of location information) associated with the users 350 and/or the obstructing vehicle 110, relationship information between the users 350 and the actual owner of the obstructing vehicle 110, analysis of scheduling information associated with the users 350, a random ordering of the users 350, traffic information, and weather information.

Moreover, if no one in the selected group indicates availability to respond to the notifications, the notifications may then be sent to another selected group of the users 350 in the order. Furthermore, an option to toggle the notifications on and off may be provided to any of the selected groups of users. It should be understood that the present disclosure is not limited to the above examples and that various other implementations for notifying multiple users 350 are also possible.

According to one or more embodiments, once a user 350 has been notified of the obstructing vehicle 110, the central server 310 may send a signal to the in-vehicle computation system 340 to communicate with the approaching person 130. The central server 340 may perform this action as a direct response to user 350 instruction or may be configured to do so automatically after having notified the user 350. Alternatively, the central server 310 may communicate directly with the mobile device 330b of the approaching person 130. In yet another embodiment, the in-vehicle computation system 340 may directly communicate with the approaching person 130 without receiving a signal from the central server 310. The communication to the approaching person 130 may be a predetermined response or it may be dynamically created in real-time by the user 350. For example, the predetermined response may be a recorded message or a default message to be displayed.

According to some embodiments, the central server 310 and/or the in-vehicle computation system 340 may initiate communication directly with the approaching person 130. The communication may be performed using a display on the in-vehicle computation system 340 or a projected display on the obstructing vehicle 110 itself. As another example, a speaker may be coupled to the obstructing vehicle 110 to communicate with the approaching person 130. In yet another example, a signal may be sent to display the communication on the mobile device 330b of the approaching person 130. It is understood that the present disclosure is not limited to the above examples and that other methods of communicating with the approaching person 130 are also possible.

To this end, the communication may include indicating to the approaching person 130 an intention to move the obstructing vehicle 110 and/or an apology for having blocked the obstructed vehicle 120. The communication may also include any recorded audio/video message that may be played either automatically, or at the direction of the user 350, central server 310, and/or in-vehicle computation system 340. In addition, the communication may include periodically updating the approaching person 130 with location information associated with the user 350. For example, if the user 350 has decided to come and move the obstructing vehicle 110, the updates may show that the user 350 is gradually approaching the location of the obstructing vehicle 110 and the approaching person 130. Thus, the emotions of the approaching person 130 may be ameliorated due to satisfaction with the knowledge that the user 350 is coming to move the obstructing vehicle 110.

As another example, the in-vehicle computation system 340 may be capable of outputting media content to entertain the approaching person 130 while he/she waits for someone to move the obstructing vehicle 110. According to some embodiments, the media content may be stored in the in-vehicle computation system 340. In other embodiments, the media content may be stored on the central server 310 and streamed to the in-vehicle computation system 340. In yet other embodiments, the media content may be stored remotely, such as on a website on the Internet, and may be downloaded and/or streamed by the in-vehicle computation system 340 or the central server 310. Accordingly, the media content may include any combination of audio, video, and image data.

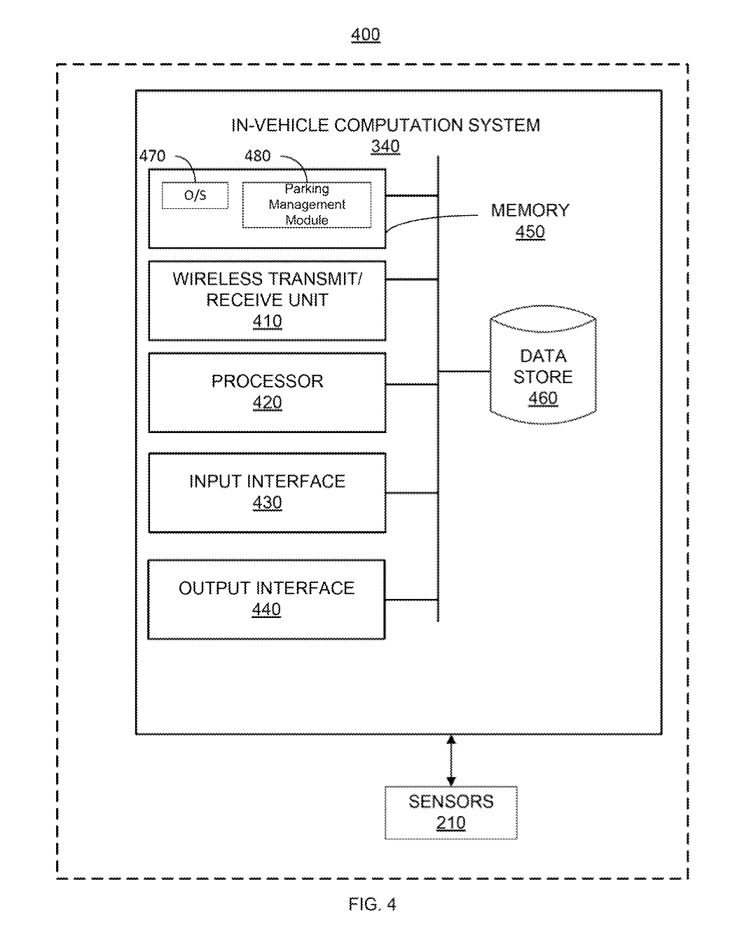

FIG. 4 shows an example embodiment of a system 400 suitable for implementing methods for interactive management of a parked vehicle. The system 400 may include an in-vehicle computation system 340 or a mobile device. As shown in the figure, the system 400 may comprise a wireless transmit/receive unit 410, one or more processors 420, an input interface 430, an output interface 440, a memory 450, and a data store 460. The memory may 450 may also store an operating system (O/S) 470 and a parking management module 480. Additionally, the in-vehicle computation system 340 may be coupled to sensors 210 and may receive various information, as described above, from the sensors 210.

The wireless transmit/receive unit 410 may be configured to receive data from a communications network 320 and transmit data to the communications network 320. In some embodiments, the wireless transmit/receive unit 410 may establish communications between the elements 420-480. The one or more processors 420 may be configured to execute instructions stored in memory 450, such as instructions provided by the operating system 470 and/or the parking management module 480.

According to some embodiments, the parking management module 480 may be configured to perform one or more logic operations related to various methods for interactive management of a parked vehicle as described herein. For example, the parking management module 480 may be configured to detect, via the sensors 210 on the obstructing vehicle 110, that an approaching person 130 considers the vehicle 110 an obstruction. The parking management module 480 may also be configured to notify one or more users 350 associated with the obstructing vehicle 110 that the approaching person 130 considers the vehicle 110 and obstruction. In some embodiments, the parking management module 480 may be configured to communicate, to the approaching person 130, an intention to move the obstructing vehicle 110.

The input interface 430 may be configured to enable one or more individuals to make various inputs. The inputs may include tasks, selections, routes, addresses, locations, user profiles, policies, task rankings, settings, constraints, and so forth. The input interface 430 may include one or more of a keypad, a touchscreen, a touchpad, a trackball, a microphone, voice recognition hardware/software, and so forth. Additionally, the input interface 430 may also include, or may be otherwise associated with, the sensors 210 to facilitate detection of an approaching person 130. For example, the input interface 430 may receive a signal from the sensors 210 indicating detection of an approaching person 130. The input interface 430 may then communicate with the parking management module 480 to generate a response to the indication.

The output interface 440 may be configured to present to one or more individuals text messages, video messages, images, multimedia messages, audio messages, voice messages, mechanical signals, and so forth. The output interface 440 may include a display such as a light-emitting diode (LED) display, an organic light-emitting diode (OLED) display, a liquid crystal display (LCD), an electrophoretic display, and so forth. The output interface 440 may also include speakers and a vibration machine to generate vibrations. As such, the speakers may be configured to transmit voice signals, such as a pre-recorded message or a dynamically synthesized voice. Additionally, the speakers may transmit voice signals directly from the user's 350 mobile device 330a.

Furthermore, the output interface 440 may be configured to communicate with the approaching person 130. For example, the output interface 440 may indicate to the approaching person 130 that a user 350 is coming to move the obstructing vehicle 110 and apologize for the obstruction. As another example, the output interface 440 may communicate location information of a user 350 to the approaching person 130. In yet another example, the output interface 440 may provide media content to the approaching person 130 or the mobile device 330b of the approaching person 130. As described above, such communication with the approaching person 130 may be any combination of audio, video, and image data.

In some embodiments, a navigational unit (not illustrated) may be configured to determine a current location of the in-vehicle computation system 340. The current location may be determined by receiving and processing signals of the GPS or any other satellite system. Alternatively, the location may be determined by processing multilateration data associated with the in-vehicle computation system 340. The multilateration location determination may be based on auxiliary data received from cellular network base stations, web servers, network routers, and so forth. The navigational unit may also provide navigation for the users by generating routes, paths, and travel tips; overlaying routes over digital maps; processing traffic information; and so forth.

The memory 450 may be configured to store data needed for operation of the in-vehicle computation system 340. This data may include tasks, selections, digital certificates, notifications, reminders, suggestions, routes, calendar data, traffic data, digital maps, virtual profiles, settings, policies, and so forth.

Additionally, while the parking management module 480 is depicted as being located in the in-vehicle computation system 340, it should be understood that the logic performed by the parking management module 480 may also be present in other devices as well. For example, the parking management module 480 may also be located in the central server 310 and/or on a mobile device 330a-b.

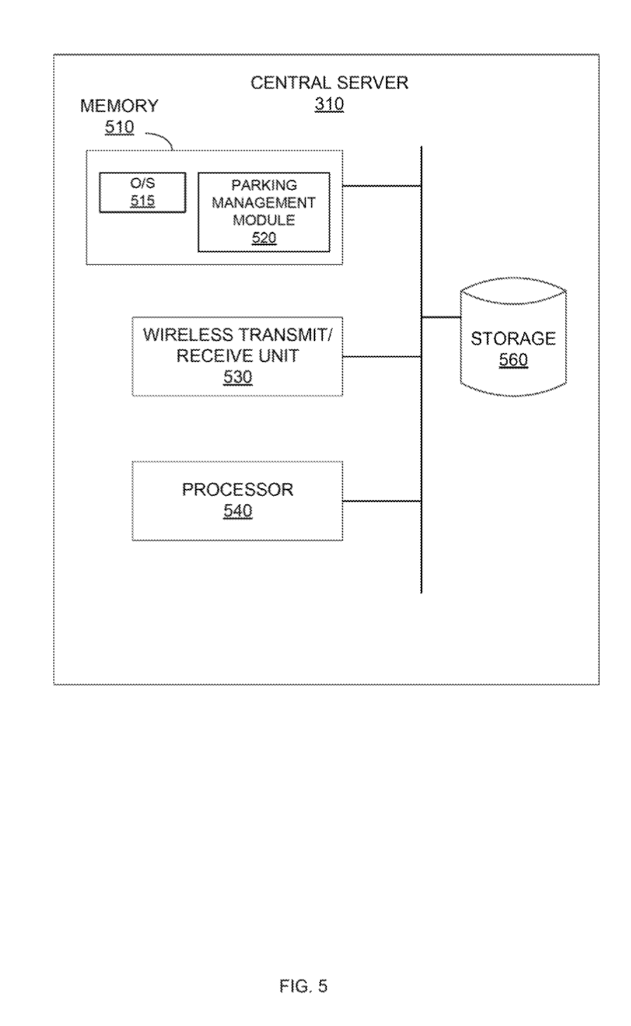

FIG. 5 depicts a central server 310 suitable for implementing methods for an interactive parking management system in accordance with multiple embodiments. As shown, FIG. 5 may illustrate embodiments in which the parking management system 380 may be located in the central server 310. The central server 310 may also comprise a memory 510, wireless transmit/receive unit 530, one or more processors 540, and storage 560. The memory may 510 may also store an operating system (O/S) 515 and the parking management module 520.

The wireless transmit/receive unit 530 may be configured to receive data from a communications network 320 and transmit data to the communications network 320. In some embodiments, the wireless transmit/receive unit 530 may establish communications between the elements 510-560. The one or more processors 540 may be configured to execute instructions stored in memory 510, such as instructions provided by the operating system 515 and/or the parking management module 520.

According to some embodiments, the parking management module 520 may be configured to perform one or more logic operations related to various methods for interactive management of a parked vehicle as described herein. For example, the parking management module 520 may be configured to detect, via the sensors 210 on the obstructing vehicle 110, that an approaching person 130 considers the vehicle 110 an obstruction. For instance, once the sensors 210 have made such detection, an indication of the detection may be sent to the parking management module 520. Such an indication may be sent to the parking management module 520 from the in-vehicle computation system 340, the approaching person's 130 mobile device 330b, and/or any other device.

Alternatively, as described above with reference to FIG. 3, the parking management module 520 may be configured to periodically poll or monitor the sensors 210. Such polling and/or monitoring may be associated directly with the sensors 210 or may be performed by monitoring the in-vehicle computation system 340, which itself may be coupled to the sensors 210.

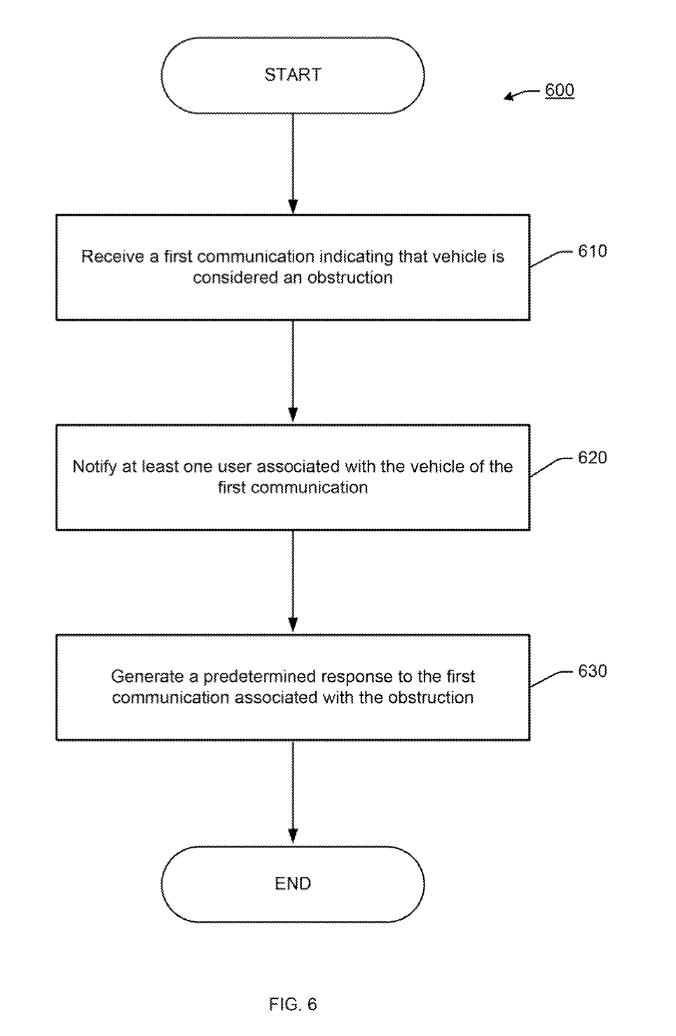

Moreover, the parking management module 520 may also be configured to notify one or more users 350 associated with the obstructing vehicle 110 that the approaching person 130 considers the vehicle 110 an obstruction. As previously mentioned, the notification may be made in various forms, such an email message, a text message, a voice message, a phone call, and/or the like. In some embodiments, the parking management module 520 may also be configured to communicate to the approaching person 130, via the in-vehicle computation system 340, the approaching person's 130 mobile device 330b, and/or any other device, an intention to move the obstructing vehicle 110. Turning now to FIG. 6, a flow diagram illustrating a method 600 for interactive management of a parked vehicle is shown. In one or more embodiments, the method 600 may be depicted from the perspective of a central server 310.

The method 600 may begin at block 610 where a system, such as the central server 310, may receive a first communication indicating that a vehicle (e.g., the obstructing vehicle 110) is considered an obstruction. For example, the first communication may be received by the in-vehicle computation system 340 and/or directly by the sensors 210. In some embodiments, detection of an approaching person 130 may represent an indication that the vehicle 110 is considered an obstruction (i.e., the approaching person 130 considers the vehicle 110 an obstruction to the obstructed vehicle 120).

According to other embodiments, the first communication may include any type of message sent to the user 350 or the mobile device 330a of the user. For example, the first communication may include a text message or an email sent to the user's 350 mobile device 330a. The first communication may also include a voicemail left for a phone number associated with the user 350. Additionally, the first communication may include any other type of message or alert associated with an application associated with the mobile device 330a and/or user 350.

In block 620, the central server 310 may notify one or more users 350 associated with the obstructing vehicle 110 of the first communication. In other words, the central server 310 may notify one or more users 350 that the vehicle is considered an obstruction. As previously discussed, the one or more users 350 may be anyone who holds any type of interest in the obstructing vehicle 110. Furthermore, the notification may be performed using a variety of different methods as mentioned above.

In block 630, the central server 310 may generate a predetermined response to the first communication associated with the obstruction. In one or more embodiments, the predetermined response may be a communication indicating an intention to move the obstructing vehicle 110. For example, the communication may be displayed on the in-vehicle computation system 340, projected onto the obstructing vehicle 110, so that it is visible to an approaching person 130; displayed on the mobile device 330b of the approaching person 130; and/or played through a speaker system associated with the obstructing vehicle 110.

In other embodiments, the predetermined response may be any other type of signal or communication. As an example, the predetermined response may indicate one or more methods of contacting the one or more users 350. As another example, the predetermined response may indicate location information of the one or more users 350. In yet another example, the predetermined response may provide media contact to an approaching person 130. In still another example, the predetermined response may include a signal for directing the obstructing vehicle 110 to move itself in a manner so that it is no longer an obstruction to the obstructed vehicle 120.

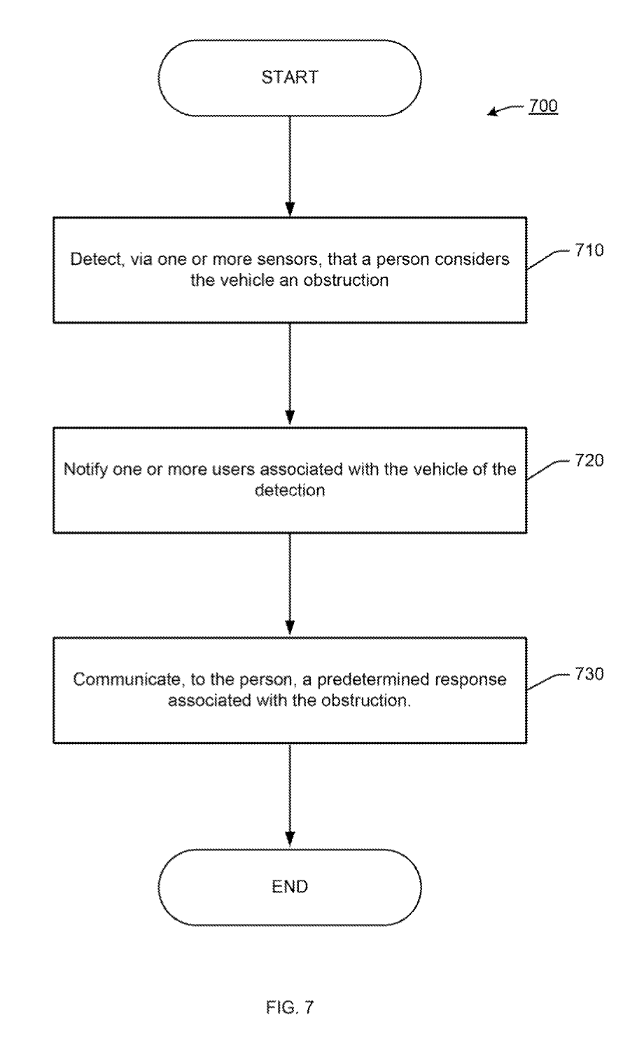

FIG. 7 depicts a flow diagram of another method 700 for interactive management of a parked vehicle. In one or more embodiments, the method 700 may be provided from the perspective of a parked vehicle, and more particularly, an in-vehicle computation system 340 in an obstructing vehicle 110.

The method 700 may begin at block 710, where the in-vehicle computation system 340 may detect, via one or more sensors 210, that a person (e.g., an approaching person 130) considers the vehicle 110 an obstruction. For example, the in-vehicle computation system 340 may wait to receive an indication of an approaching person 130 from the sensors 210. As another example, the in-vehicle computation system 340 may proactively monitor the sensors 210 to perform the detection.

In other embodiments, the central server 310 may monitor the sensor 210 for detection of an approaching person 130. In such embodiments, the in-vehicle computation system 340 may instead receive a signal from the central server 310 indicating that a person (e.g., the approaching person 130) considers the vehicle an obstruction.

In block 720, the in-vehicle computation system 340 may notify one or more users associated with the vehicle of the detection. For example, the in-vehicle computation system 340 may communicate directly with the one or more users 350 or a mobile device 330a associated with the one or more users 350. As another example, the in-vehicle computation system 340 may communicate with the central server 310 and pass on notification duties to the central server 310, which may thereby notify the one or more users 350.

At block 730, the in-vehicle computation system 340 may then communicate, to the approaching person 130, a predetermined response associated with the obstruction. In one or more embodiments, the predetermined response may be a communication indicating an intention to move the obstructing vehicle 110. In other embodiments, as described above, the predetermined response may be a pre-recorded audio and/or video message stored in the in-vehicle computation system 340, the central server 310, the user's 350 mobile device 330a, or any other device. Furthermore, in some embodiments, the response may instead by generated in real time by the user 350. For example, a message from the user 350, whether audio, video, or both, may be streamed from the user 350 or a mobile device 330a associated with the user to the central server 310. The central server 310 may then stream the message to the in-vehicle computation system 340. Alternatively, the message may be streamed from the user 350 or mobile device 330a directly to the in-vehicle computation system 340.

In other embodiments, the predetermined response may be any other type of signal or communication. As an example, the predetermined response may indicate one or more methods of contacting the one or more users 350. As another example, the predetermined response may indicate location information of the one or more users 350. In yet another example, the predetermined response may provide media contact to an approaching person 130. In still another example, the predetermined response may include a signal for directing the obstructing vehicle 110 to move itself in a manner so that it is no longer an obstruction to the obstructed vehicle 120.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for interactive management of a parked vehicle, the method comprising:
receiving a first communication, at a server comprising one or more processors, indicating that the parked vehicle is considered an obstruction;
notifying, by the server, one or more users associated with the parked vehicle of the first communication; and
generating, by the server in response to the first communication, a predetermined response associated with the obstruction.

2. The method of claim 1, further comprising transmitting the predetermined response to the parked vehicle.

3. The method of claim 1, wherein the predetermined response comprises indicating an intention to move the parked vehicle.

4. The method of claim 1, wherein the first communication comprises information associated with a QR code associated with a parked vehicle.

5. The method of claim 1, further comprising receiving, at the server, a second communication indicating that a person has approached the parked vehicle.

6. The method of claim 5, wherein the second communication comprises information associated with one or more sensors coupled to the vehicle.

7. The method of claim 6, wherein the one or more sensors comprise at least one of an image recognition system, a voice recognition system, a touch recognition system, and an accelerometer.

8. The method of claim 1, further comprising transmitting, by the server, a location information of one or more of the users to the parked vehicle.

9. The method of claim 1, further comprising transmitting a signal, by the server, instructing the vehicle to move itself.

10. The method of claim 1, wherein the first communication is sent to a selected group of the one or more users according to a predetermined order.

11. The method of claim 10, wherein the predetermined order is based on at least one of: location information associated with the one or more users, location information associated with the parked vehicle, relationship information associated with the one or more users to an owner of the parked vehicle, scheduling information associated with the one or more users, a random ordering of the one or more users, traffic information, or weather information.

12. The method of claim 10, further comprising:
receiving, at the server, a response from a particular user of the selected group to manage the vehicle; and
alerting, by the server, the other users from the selected group of the response from the particular user.

13. A vehicle comprising:
one or more sensors for detecting that a person considers the vehicle an obstruction;
at least one memory for storing data and computer-executable instructions; and
at least one processor to access the at least one memory and to execute the computer-executable instructions to:
detect, via the one or more sensors, that a person considers the vehicle an obstruction;
notify one or more users associated with the vehicle of the detection; and
communicate, to the person, a predetermined response associated with the obstruction.

14. The vehicle of claim 13, wherein the predetermined response comprises a signal indicating an intention to move the vehicle.

15. The vehicle of claim 13, wherein the one or more sensors comprise at least one of a Quick Response (QR) code, an image recognition system, a voice recognition system, a touch recognition system, and an accelerometer.

16. The vehicle of claim 13, wherein the at least one processor is to execute further instructions to notify a selected group of the one or more users according to a predetermined order.

17. The vehicle of claim 16, wherein the predetermined order is based on at least one of: location information associated with the one or more users, location information associated with the parked vehicle, relationship information associated with the one or more users to an owner of the parked vehicle, scheduling information associated with the one or more users, a random ordering of the one or more users, traffic information, or weather information.

18. The vehicle of claim 13, wherein the at least one processor is to execute further instructions to:
receive a response from a particular user of the one or more users to manage the vehicle; and
alert the other users of the one or more users of the response from the particular user.

19. The vehicle of claim 11, wherein the at least one processor is to execute further instructions to move the vehicle.

20. A computer-readable medium storing instructions that when executed by one or more processors, causes the one or more processors to:
receive, by a server comprising at least one of the one or more processors, a first communication indicating that a parked vehicle is considered an obstruction;
notify, by the server, at least one user associated with the vehicle of the first communication; and
generate, by the server in response to the first communication, a predetermined response associated with the obstruction.

21. A computer-readable medium storing instructions that when executed by one or more processors, causes the one or more processors to:
receive, from a server, an indication that a person considers a parked vehicle an obstruction; and
notify one or more users associated with the vehicle of the detection.

22. The computer-readable medium of claim 21, wherein the processor is to execute further instructions to communicate, to the person, a predetermined response associated with the obstruction.

23. The computer-readable medium of claim 22, wherein the predetermined response comprises one or more recorded messages to be played to the user.

24. The computer-readable medium of claim 21, wherein the indication comprises information associated with one or more sensors associated with the vehicle.

25. The computer-readable medium of claim 21, wherein the processor is to execute further instructions to communicate, to the person, a response associated with the obstruction, wherein the response is streamed in real-time to the person.

26. The computer-readable medium of claim 25, wherein the response comprises information associated with the one or more users.

27. The computer-readable medium of claim 25, wherein the response comprises information associated with the server.
